(19) United States
(12) Patent Application Publication
(10) Pub. No.: US 2012/0194543 A1
(43) Pub. Date: Aug. 2, 2012

(54) IMAGE DISPLAY APPARATUS, IMAGE DISPLAY METHOD AND STORAGE MEDIUM

(75) Inventor: Masayuki Sato, Tokyo (JP)

(73) Assignee: CANON KABUSHIKI KAISHA, Tokyo (JP)

(21) Appl. No.: 13/310,209

(22) Filed: Dec. 2, 2011

(30) Foreign Application Priority Data
Jan. 28, 2011 (JP) 2011-017115

(51) Int. Cl. G09G 5/00

(52) U.S. Cl. 345/619

(57) ABSTRACT

The orientation of an image display apparatus is detected and units of display data are developed from prescribed addresses of a display memory and displayed on a display device in conformity with mode of operation and the detected orientation. In case of a mode of operation in which at least two operation screens are displayed on the display device, main and subordinate units of display data are each laid out and displayed on the screen of the display device.

### BACKGROUND OF THE INVENTION

1. Field of the Invention

The present invention relates to an image display apparatus, which is capable of being removably mounted on the main unit of an apparatus, for displaying an operation screen for the purpose of operating the main unit of the above-mentioned apparatus, and to a method and a storage medium storing program for such an image display.

2. Description of the Related Art

Enhancing the operability of an image forming apparatus has been proposed by making it possible to removably mount on the main unit of the image forming apparatus a console panel for controlling the main unit of the image forming apparatus (this will be shortened to “main unit” below). Further, there is an apparatus that presents a display upon changing over the display orientation adaptively in accordance with the orientation of a display device. (For example, see the specification of Japanese Patent Laid-Open No. 11-30969.)

A console panel removably mounted on an image forming apparatus is fixed in terms of its display orientation. Accordingly, if a display conforming to the orientation in which the console panel is operated can be presented, operability can be improved. Some image forming apparatuses come equipped with various function such as a copy function and facsimile function in addition to a printing function. Such an apparatus, referred to as a multifunction peripheral, requires a variety of complicated setting operations using a console panel of the kind mentioned above.

With the apparatus described in Japanese Patent Laid-Open No. 11-30969, display data is displayed in similar fashion only in a rectangular display area capable of being displayed in the same fashion in both the vertical and horizontal orientations of the display device. Operability also is the same in both the vertical and horizontal orientations. However, such operability is no different from that in a case where the conventional console panel of an image forming apparatus is used. Thus, how to improve the operability of an image forming apparatus using a removably mounted console panel is a challenge.

### SUMMARY OF THE INVENTION

An aspect of the present invention is to eliminate the above-mentioned problems with the conventional technology.

A feature of the present invention is to provide a technique whereby, when a plurality of units of display data are displayed on a single screen, an on-screen correlation is furnished for each unit of display data and the display position and display orientation of each unit of display data are controlled in accordance with the mode of operation and the orientation of the image display apparatus when it is being operated.

According to an aspect of the present invention, there is provided an image display apparatus comprising: a detection unit configured to detect orientation of the image display apparatus; a display unit configured to display an image based upon image data that has been stored in a display memory; a storage unit configured to manage and store screen information, which is displayed on the display unit in accordance with mode of operation, at least as main and subordinate display data units; and a display control unit configured to exercise control in such a manner that the display data units that have been stored in the storage unit are developed from prescribed addresses of the display memory and displayed on the display unit in accordance with the mode of operation and the orientation that has been detected by the detection unit; wherein in the case of a mode of operation that displays at least two operation screens on the display unit, the display control unit lays out and displays each of the main and subordinate display data units on the screen of the display unit.

According to an aspect of the present invention, there is provided an image display method for controlling an image display apparatus, the method comprising: a detection step of detecting orientation of the image display apparatus; a display step of displaying an image based upon image data that has been stored in a display memory; a storage step of managing and storing, in a memory, screen information, which is displayed on the display unit in accordance with mode of operation, at least as main and subordinate display data units; and a display control step of exercising control in such a manner that the display data units that have been stored in the memory are developed from prescribed addresses of the display memory and displayed on the display unit in accordance with the mode of operation and the orientation that has been detected in the detection step; wherein in the case of a mode of operation that displays at least two operation screens on the display unit, each of the main and subordinate display data units are laid out and displayed on the screen of the display unit in the display control step.

Further features and aspects of the present invention will become apparent from the following description of exemplary embodiments, with reference to the attached drawings.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 depicts a schematic view illustrating the environment in which an image forming apparatus according to an embodiment is utilized;

FIG. 2 is a block diagram for describing the configurations of a main unit, home position and console panel according to a first embodiment;

FIG. 3 is a flowchart for describing processing, which is executed by a console panel, for detecting orientation of the console panel according to the first embodiment;

FIGS. 4A to 4D are diagrams for describing console panel orientations and display orientations;

FIGS. 5A and 5B are diagrams illustrating examples of units of display data displayed on a console panel;

FIGS. 6A and 6B are diagrams illustrating examples of units of display data displayed on a console panel;

FIG. 7 is a flowchart for describing the details of input display processing at a step S9 in FIG. 3;

FIG. 8 is a diagram useful in describing data that specifies combinations of master and slave windows;

FIG. 9 is a diagram illustrating an example a main menu screen according to the first embodiment;

FIG. 10 is a diagram illustrating an example in which a main menu screen and a box selection window are displayed;

FIG. 11 is a diagram illustrating a boxed-document list window and a boxed-document preview window;

FIG. 12 is a diagram illustrating an example of a boxed-document preview window;

FIG. 13 is a diagram illustrating an example of a boxed-document print settings window and an advanced print settings window;

FIG. 14 is a diagram illustrating an example of an advanced print settings window;

FIG. 15 is a diagram illustrating an example of a print execution window and job status window;

FIG. 16 is a diagram illustrating an example of a job status window;

FIG. 17 is a block diagram illustrating the configurations of a console panel and home position according to a second embodiment;

FIG. 18 is a flowchart for describing processing for detecting orientation of a console panel according to a second embodiment; and

FIG. 19 is a block diagram illustrating the configurations of a console panel, which has a three-dimensional gyrosensor, and home position according to another embodiment.

### DESCRIPTION OF THE EMBODIMENTS

Embodiments of the present invention will be described hereinafter in detail, with reference to the accompanying drawings. It is to be understood that the following embodiments are not intended to limit the claims of the present invention, and that not all of the combinations of the aspects that are described according to the following embodiments are necessarily required with respect to the means to solve the problems according to the present invention. This embodiment will be described taking as an example a console panel removably mounted as an image display apparatus on an image forming apparatus. However, the present invention is not limited to this example.

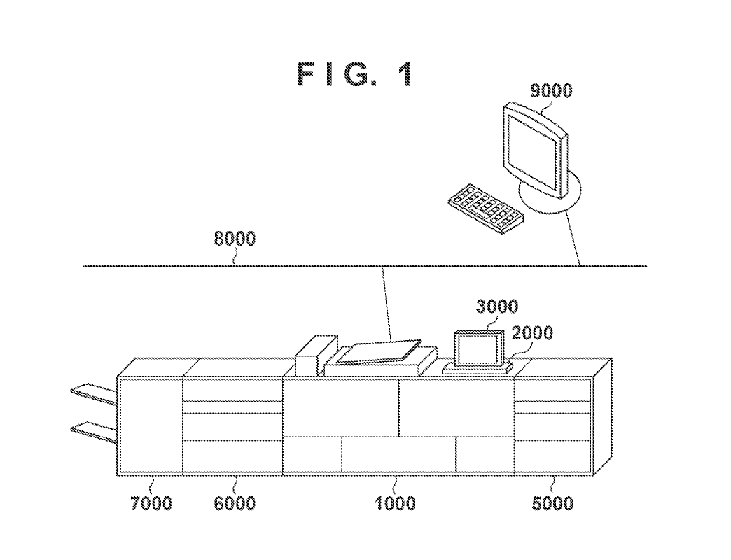

FIG. 1 depicts a schematic view illustrating the environment in which an image forming apparatus according to this embodiment of the present invention is utilized.

The image forming apparatus according to this embodiment is a so-called Print On Demand (POD) machine and responds to the need for a wide variety of printing and binding operations by combining various options that enable such operations as saddle stitching, cutting and folding to be carried out. This image forming apparatus illustrates an example in which a paper feed deck 5000, binder 6000 and finisher 7000 have been combined with a main unit 1000 of the apparatus.

The main unit 1000 is connected to a personal computer 9000 via a LAN 8000. The personal computer 9000 generates a print job, from creation and editing of each page of data to the setting of binding, cutting and folding operations and the like. The print job thus generated is sent from the personal computer 9000 to the main unit 1000 via the LAN 8000.

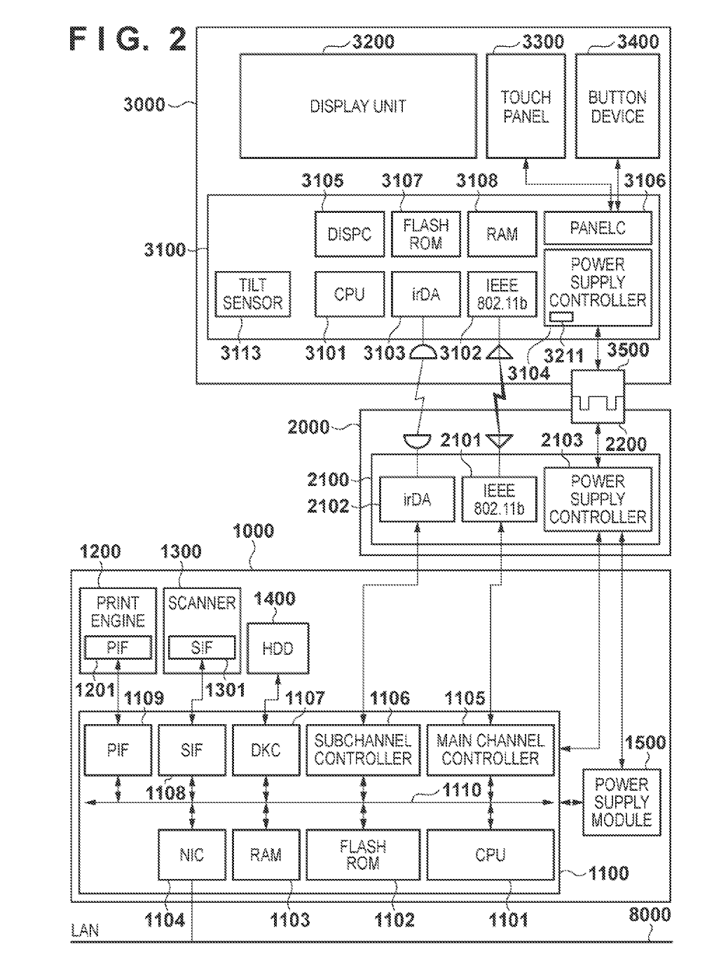

A removable console panel 3000, which is a characterizing feature of this embodiment, is mounted at a home position 2000 provided on the main unit 1000. When the removable console panel 3000 has been mounted at the home position 2000, a built-in battery 3211 (see FIG. 2) is charged by power supplied from the home position 2000.

It should be noted that since options such as the paper feed deck 5000, binder 6000 and finisher 7000 are not directly related to the gist of this embodiment, the details thereof need not be described.

FIG. 2 is a block diagram for describing the configurations of the main unit 1000, home position 2000 and console panel 3000 according to the first embodiment. Modules that construct the main unit 1000, home position 2000 and console panel 3000 will be described below.

The main unit 1000 will be described first.

As shown in FIG. 2, the main unit 1000 has a controller board 1100, a print engine 1200, a scanner 1300, a hard-disk drive (HDD) 1400 and a power supply module 1500. These components are operated by power supplied from the power supply module 1500.

The controller board 1100 has a CPU 1101, a flash ROM 1102, a RAM 1103, a network interface card (NIC) 1104, a main channel controller 1105, a subchannel controller 1106, a disk controller (DKC) 1107, a scanner interface (SIF) 1108 and a printer interface (PIF) 1109. These devices 1101 to 1109 are connected to the CPU 1101 via a bus 1110.

The CPU 1101 is a processor for exercising overall control of the devices connected to the bus 1110 and for executing a control program stored in the flash ROM 1102 and HDD 1400. The RAM 1103 is used as the main memory and work area of the CPU 1101. The NIC 1104 exchanges data with the personal computer 9000 and another image forming apparatus bidirectionally via the LAN 8000. The HDD 1400 is accessed via the DKC 1107 and not only stores the control program but is also used as a temporary storage location for image data.

The scanner 1300 has a read sensor and a document feed mechanism, etc., which are not shown. The read sensor and document feed mechanism, etc. are controlled in accordance with software executed by the CPU 1101 via the SIF 1108 mounted on the controller board 1100 and a SIF 1301 mounted on the scanner 1300. As a result, a document is read by the read sensor and the data obtained is transferred to the controller board 1100 via the SIFs 1301 and 1108.

The print engine 1200 has an electrophotographic printing unit, a printing paper cassette and a paper conveyance unit, etc., none of which are shown. A print request based upon the print job is sent from the controller board 1100 via the PIF 1109 and a PIF 1201, which is mounted on the print engine 1200. Similarly, the printing unit and paper conveyance unit, etc., are controlled based upon a program, which is executed by the CPU 1101, via the PIFs 1109 and 1210. As a result, an image conforming to the print request is formed on the printing paper.

The main channel controller 1105 and subchannel controller 1106 are used when the main unit 1000 and demountable console panel 3000 exchange data and information. The details will be described later.

The home position 2000 will be described next.

As shown in FIG. 2, the home position 2000 has a main board 2100 and a connector 2200. The main board 2100 mainly includes an IEEE 802.11b module 2101, an irDA module 2102 and a power supply controller 2103. The IEEE 802.11b module 2101 is connected to the main channel controller 1105 of the controller board 1100 and mediates wireless communication with the console panel 3000 based upon a request from the controller board 1100. The irDA module 2102 is connected to the subchannel controller 1106 of the controller board 1100 and mediates infrared communication with console panel 3000. The power supply controller 2103 is connected to the power supply module 1500. The IEEE 802.11b module 2101 and irDA module 2102 receive supply of power through the power supply controller 2103. The power supply controller 2103 is connected to the connector 2200 and supplies electric power also to the console panel 3000 when contact is made with a connector 3500 of the console panel 3000. In addition, the power supply controller 2103 monitors the status of supply of electric power, detects whether the console panel 3000 is in a state in which it has been mounted on the home position 2000 and transfers the result of detection to the controller board 1100.

The console panel 3000 will be described next.

The removable console panel 3000 mainly includes a main board 3100, a display unit (LCD) 3200, a touch panel 3300, a button device 3400 and the connector 3500. The main board 3100 has a CPU 3101, an IEEE 802.11b module 3102, an irDA module 3103, a power supply controller 3104, a display controller (DISPC) 3105, a panel controller (PANELC) 3106, a flash ROM 3107 and a RAM 3108. These modules 3101 to 3108 are similarly connected to the controller board 1100 by a bus (not shown).

The CPU 3101 is a processor for exercising overall control of the devices connected to the bus and for executing a control program stored in the flash ROM 3107. The RAM 3108 functions as the main memory and work area of the CPU 3101 and as a storage area (display memory) for video data displayed on the display unit 3200. The CPU 3101 is capable of recognizing the orientation (portrait or landscape orientation) of the console panel 3000 using a tilt sensor 3113. The portrait orientation is one in which the short side of the console panel 3000 lies approximately parallel to the ground (floor) when the panel has been rotated, and the landscape orientation is one in which the long side of the console panel 3000 lies approximately parallel to the ground (floor) when the panel has been rotated.

The display controller (DISPC) 3105 transfers video data, which has been developed in the RAM 3108, to the display unit 3200 in response to a request from the CPU 3101 and displays this video data by controlling the display unit 3200. The panel controller (PANELC) 3106 controls the touch panel 3300 and button device 3400 in accordance with a request from the CPU 3101. By virtue of such control, a position at which the touch panel 3300 has been pressed or a key code or the like corresponding to a button pressed on the button device 3400 is sent back to the CPU 3101.

The power supply controller 3104 is connected to the connector 3500 and receives supply of power from the power supply module 1500 of the main unit 1000 when the connector 3500 is in contact with the connector 2200 of the home position 2000. As a result, electric power is supplied to the entire console panel 3000 while the battery 3211 connected to the power supply controller 3104 is being charged. If electric power is not supplied from the power supply module 1500, then electric power from the battery 3211 is supplied to the entire console panel 3000.

Under the control of the CPU 3101, the IEEE 802.11b module 3102 establishes wireless communication with the IEEE 802.11b module 2101 of home position 2000 and mediates communication with the main unit 1000. Under the control of the CPU 3101, the irDA module 3103 establishes infrared communication with the irDA module 2102 on the home position 2000 and mediates communication with the main unit 1000.

Wireless communication serving as the main channel according to this embodiment will be described next.

As touched upon in the description of FIG. 2, wireless communication serving as the main channel is performed in compliance with the well-known specifications of IEEE 802.11b according to this embodiment. More specifically, in the system according to this embodiment, wireless communication is carried out in an infrastructure mode in which the main unit 1000 serves as an access point (AP) and the console panel 3000 serves as a terminal.

It is arranged so that if a plurality of main units happen to reside in an area reached by radio waves from the console panel 3000, the ESSIDs of the plurality of main units that are capable of communicating with the console panel 3000 are displayed on the display unit 3200 of console panel 3000 and any one can be selected, as in the manner of an already existing personal computer.

After a communicating party is established by association, the console panel 3000 operates as a thin client in which detection of an input made by the operator using the touch panel 3300 or button device 3400 and presentation of a display on the display unit 3200 are performed in order that the operator may control operation of the main unit 1000. That is, almost all management of status of the main unit 1000 and almost all processing for generating print data is executed by the CPU 1101 of main unit 1000. The status of the main unit 1000 is sent from the main unit 1000 to the console panel 3000 wirelessly according to a predetermined protocol. On the other hand, the CPU 3101 controls the display presented by the display unit 3200 in accordance with information relating to user operation of the touch panel 3300 and button device 3400 of the console panel 3000 and requests the main unit 1000 for information, which relates to the main unit 1000, conforming to the operation performed by the operator. A command such as for starting operation of the main unit 1000 under conditions set by the operator is sent to the main unit 1000 wirelessly together with the information.

Thus, the system according to this embodiment is one in which the main unit 1000 and console panel 3000 are capable of communicating wirelessly.

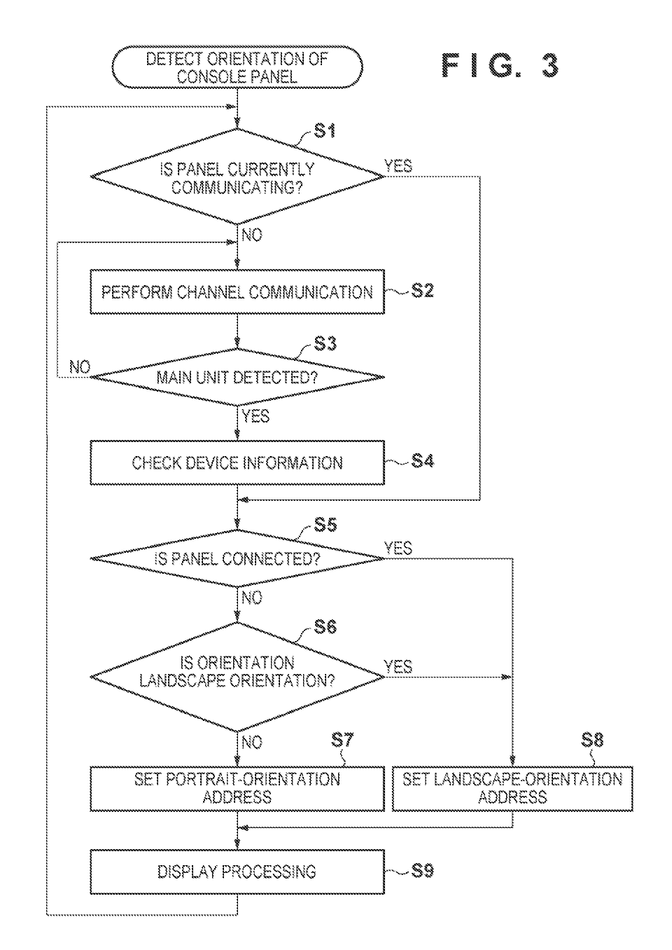

Next, reference will be had to the flowchart of FIG. 3 to describe processing executed by the console panel 3000 for the purpose of detecting its orientation.

FIG. 3 is a flowchart for describing processing, which is executed by the console panel 3000, for detecting the orientation of the console panel 3000 according to the first embodiment. The program for executing the processing shown in this flowchart has been stored in the flash ROM 3107. Detection is implemented by having the CPU 3101 execute this program.

First, in step S1, the CPU 3101 of console panel 3000 discriminates the state of wireless communication on the main channel and determines whether wireless communication with the main unit 1000 is in progress. If the CPU 3101 determines that wireless communication on the main channel is not in progress, control proceeds to step S2. Here the CPU 3101 sends the main unit 1000 a request for establishing main-channel communication with the main unit 1000. If the CPU 3101 determines that communication is in progress, on the other hand, then control proceeds to step S5. It should be noted that if a plurality of main units happen to reside in an area reached by the radio waves of the main channel, the ESSIDs of the plurality of main units that are capable of communicating with the console panel 3000 are displayed on the console panel 3000, the user is allowed to select any one of them and the above-mentioned request is transmitted to the main unit of the ESSID selected. When control proceeds to step S3, the CPU 3101 determines whether the main unit 1000 has been detected, which depends upon whether a response from the main unit 1000 has been received to the effect that communication is allowed. The CPU 3101 repeats the processing of steps S2 and S3 until it detects the main unit 1000.

If the CPU 3101 determines in step S3 that the main unit 1000 has been detected, then the CPU 3101 establishes main-channel communication with the main unit 1000 and control proceeds to step S4. Here the CPU 3101 checks device information such as the device ID of the main unit 1000 and the valid functions thereof. More specifically, the CPU 3101 transmits a device information request (a request to check device information such as the device ID of the main unit 1000 and the valid functions thereof) and receives this device information from the main unit 1000. Control then proceeds to step S5. Here the CPU 3101 determines whether the console panel 3000 has been placed at the home position 2000 on the main unit 1000 and is connected to the main unit 1000. If it is determined that the console panel 3000 and main unit 1000 are connected, control branches to step S8 and the CPU 3101 executes processing for presenting a display in the landscape orientation unequivocally. On the other hand, if it is determined in step S5 that the console panel 3000 and main unit 1000 are not connected, then control proceeds to step S6. Since the state in effect in step S6 in one in which the operator has demounted the console panel 3000 from the main unit 1000, the CPU 3101 determines from the output of the tilt sensor 3113 whether or not the orientation of the console panel 3000 is the landscape orientation. If it is determined that the orientation is the landscape orientation based upon the output of the tilt sensor 3113, then control branches to step S8. Here the CPU 3101 performs a display-data address setting for performing landscape-orientation display processing and then executes display processing in step S9. On the other hand, if it is determined in step S6 that the orientation is the portrait orientation based upon the output of the tilt sensor 3113, then control branches to step S7. Here the CPU 3101 performs a display-data address setting for performing portrait-orientation display processing and then executes display processing in step S9. It should be noted that the processing of steps S1 to S9 is repeated as long as power is being supplied to the console panel 3000.

### First Embodiment

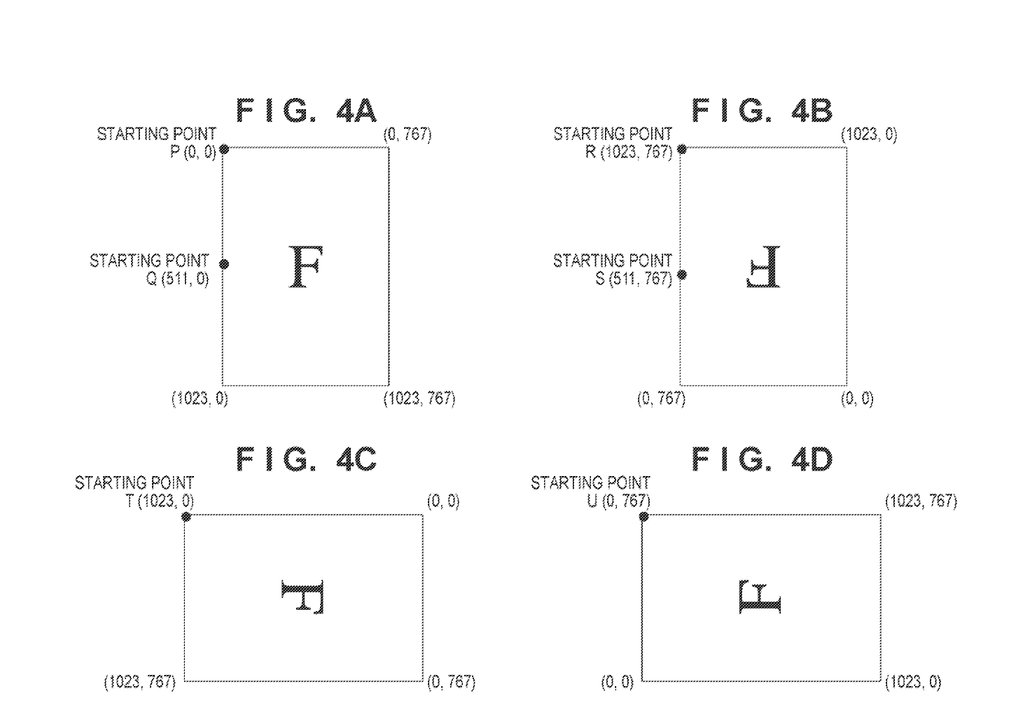

FIGS. 4A to 4D are diagrams for describing orientations of the console panel 3000 and display orientations. There are two types of portrait orientation, namely those shown in FIGS. 4A and 4B, and two types of landscape orientation, namely those shown in FIGS. 4C and 4D.

The portrait-orientation address setting made in step S7 is a case where the user operates the console panel 3000 upon placing it in the portrait orientation. In a case where the portrait orientation shown in FIG. 4A is detected by the tilt sensor 3113, the starting points of the display data are assumed to be P(0,0) and Q(511,0) for each unit of display data. In the first embodiment, a unit of display data that begins at starting point P will be described as a main display data unit, and a unit of display data that begins at starting point Q will be described as a subordinate display data unit. The display area of the display unit 3200 used in the first embodiment is a rectangular area of 1024×768 pixels, and two different display data units each having 512×768 pixels of display data can be displayed from respective ones of both starting points without overlapping each other.

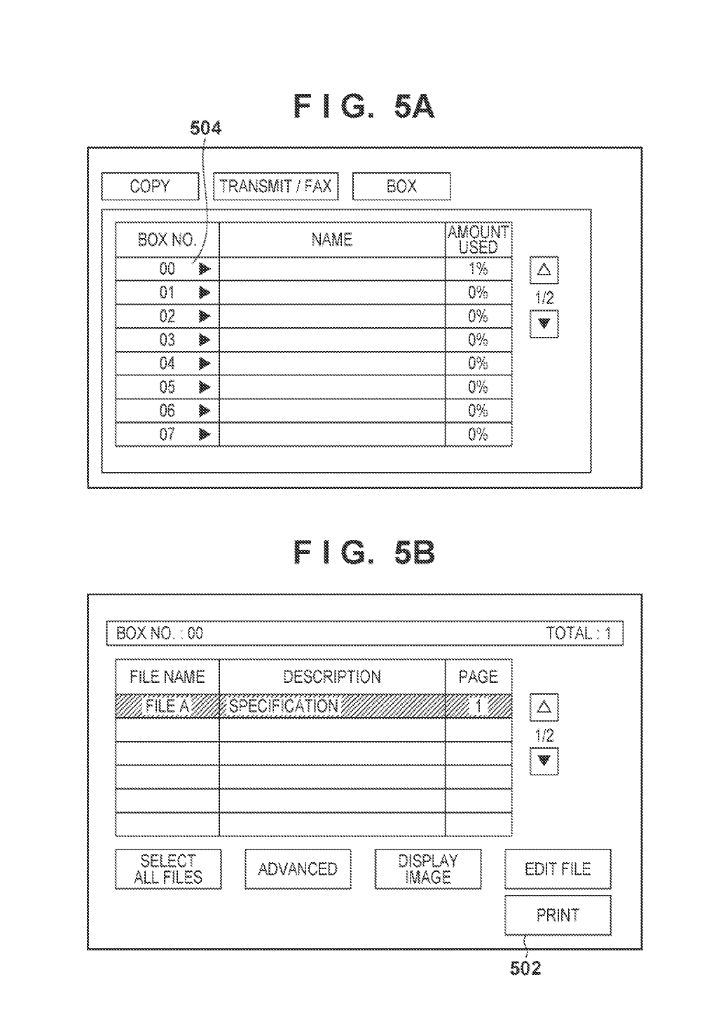

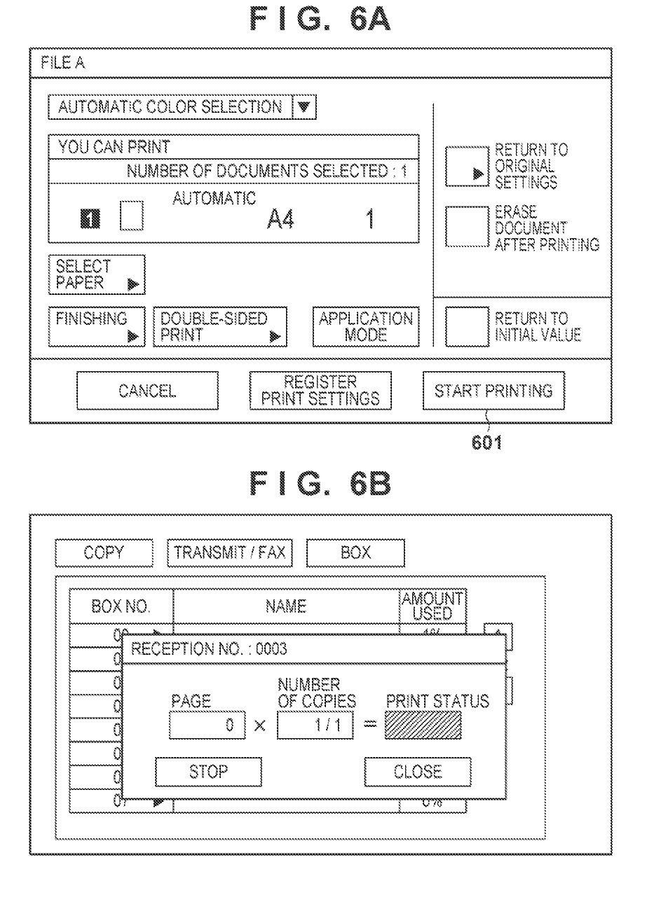

FIGS. 5A, 5B, 6A and 6B are diagrams illustrating examples of units of display data display on the console panel 3000.

FIG. 5A shows a unit of display data displayed in a case where a boxed-document print function corresponding to a box button 901 has been selected from a main menu shown in FIG. 9. This data unit usually is developed as an image of 768×512 pixels from an address of RAM 3108 that corresponds to the starting point P (FIG. 4A). In the box selection window of FIG. 5A, whether data has been stored in each box is displayed in the form of amount used. A boxed-document list window shown in FIG. 5B shows a unit of display data that displays a list of boxed documents of a selected box in FIG. 5A. A boxed document to be printed is selected from this document list. FIG. 6A is a unit of display data in a boxed-document print settings window for printing a boxed document selected in the boxed-document list window of FIG. 5B. The units of display data of FIGS. 5A, 5B and FIG. 6A are all developed as images of 768×512 pixels each in RAM 3108 from the address corresponding to the starting point P (FIG. 4A) of RAM 3108. The units of display data illustrated in FIGS. 5A, 5B and 6A are items of display data displayed by a display device having an 8-inch size conventionally provided on the main unit. Further, FIG. 6B illustrates a unit of display data in a print execution window displayed when a boxed document is actually being printed. It should be noted that the display data of these units of display data has been stored in the flash ROM 3107.

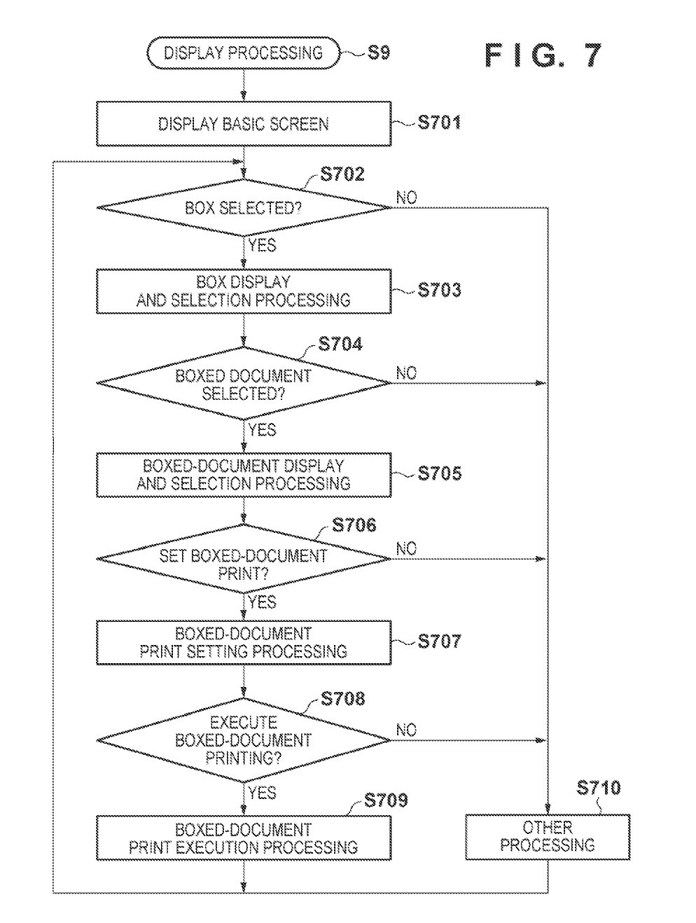

Next, reference will be had to the flowchart of FIG. 7 taking as an example a case where a boxed document is printed. This flowchart illustrates the details of the display processing of step S9 in FIG. 3. The program and data relating to this flowchart have been stored in the flash ROM 3107 of console panel 3000, and the program is read out to the RAM 3108 and executed by the CPU 3101. Further, the program may be supplied from the main unit 1000 through the IEEE 802.11b module 3102 and IEEE 802.11b module 2101 in response to a command from the touch panel 3300 or the button device 3400 of the console panel 3000. Further, IEEE 802.11b is one example of a communication standard and the present invention is not limited to this communication standard.

In the processing shown in FIG. 7, first the panel controller (PANELC) 3106 reads in the starting address of display data that conforms to the orientation of the console panel 3000. Executed in steps S701, S703, S705, S707 and S709 is processing for detecting user operation of the console panel 3000, processing for specifying the relationship of data units, and screen display processing for laying out and displaying screens associated with the main display data unit and subordinate display data unit.

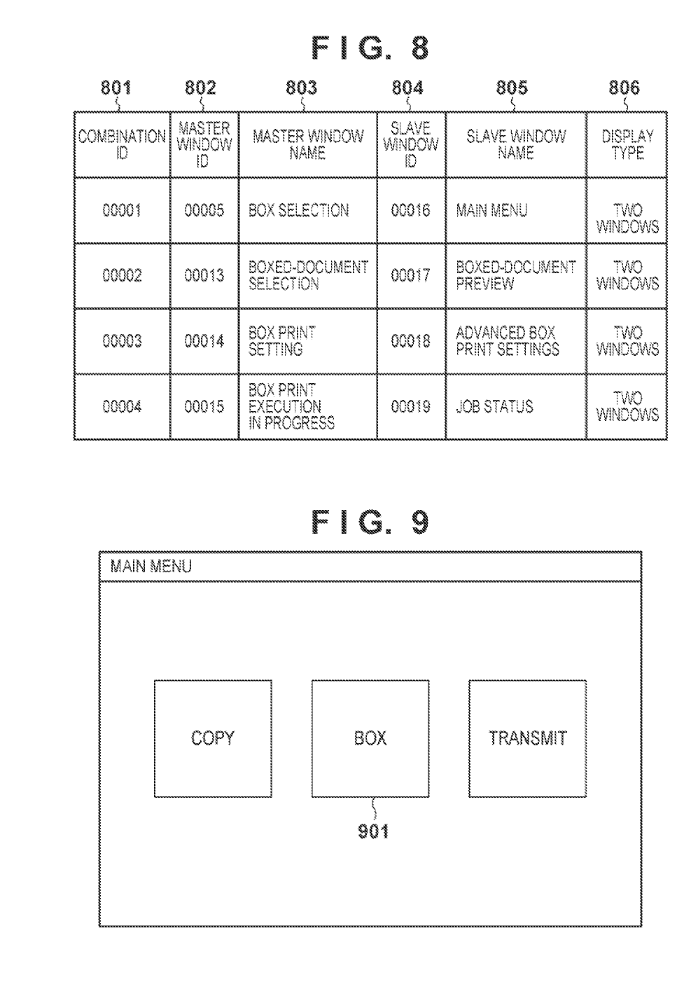

In the case of the portrait orientation shown information processing apparatus 4A, the addresses of RAM 3108 corresponding to starting points P(0,0) and Q(511,0) are set in accordance with the description rendered forth above. The two units of display data that are to be displayed are classified as a main display data unit and a subordinate display data unit each developed in RAM 3108 from flash ROM 3107 with starting points P and Q, respectively, serving as their starting points. The starting points at which the display data units are read out of RAM 3108 are adopted as addresses corresponding to the respective starting points P, Q, and the image data that has been read out of RAM 3108 is developed in the display memory in such a manner that images of 768×512 pixels are displayed along the diagonal direction, whereby the units of display data are displayed on the display unit 3200. The items of window information displayed from the respective starting points P and Q become a combination shown in FIG. 8, described later. Further, the data shown in FIG. 8 has been stored in flash ROM 3107 or HDD 1400.

The processing of each step of FIG. 7 will now be described.

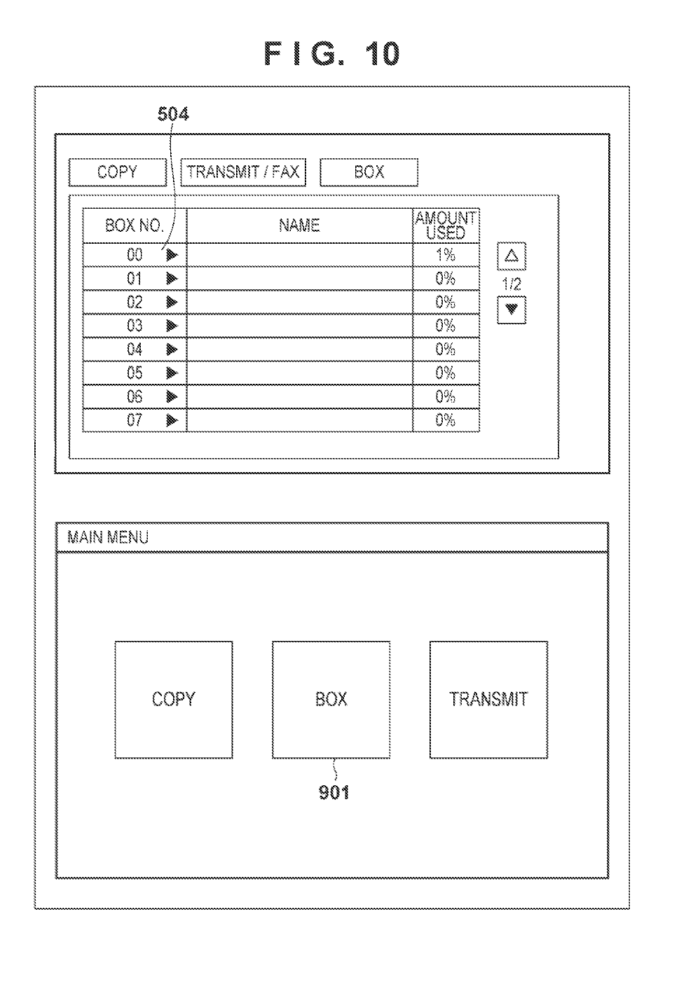

First, in step S701, the panel controller (PANELC) 3106 displays the main menu screen (FIG. 9). Next, if the operator presses a box button 901 on the main menu screen in step S702, control proceeds from step S702 to step S703 and the panel controller (PANELC) 3106 displays the main menu screen and the box selection window, as illustrated in FIG. 10.

FIG. 10 is a diagram in which the main menu screen and box selection window are displayed.

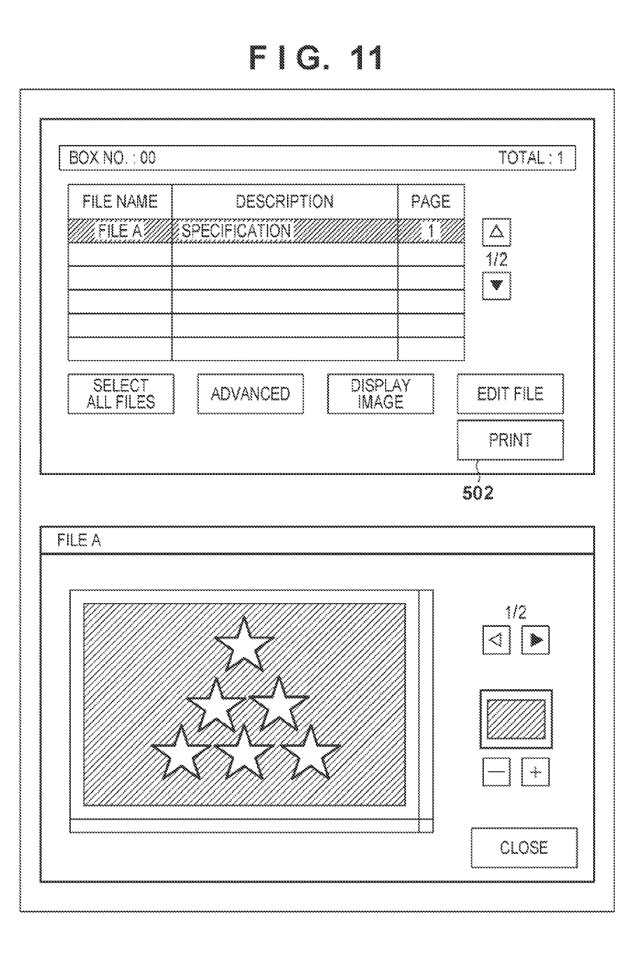

In this display, the panel controller (PANELC) 3106 displays the box selection window, which is shown in FIG. 5A, from starting point P and displays the main menu screen, which is shown in FIG. 9, from starting point Q. Next, if a box number selection key 504 (FIG. 10) in the box selection window is pressed, control proceeds from step S704 to step S705, which is for presenting the boxed-document list display. In step S705, the panel controller (PANELC) 3106 displays the boxed-document list window and a boxed-document preview window, as illustrated in FIG. 11.

FIG. 11 is a diagram illustrating the boxed-document list window and the boxed-document preview window according to the first embodiment.

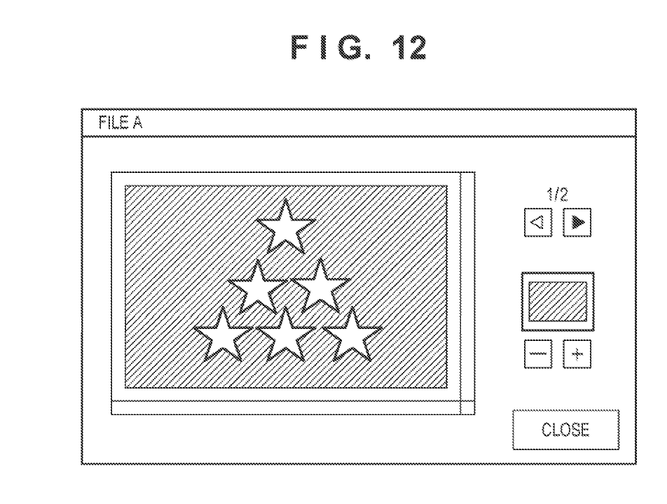

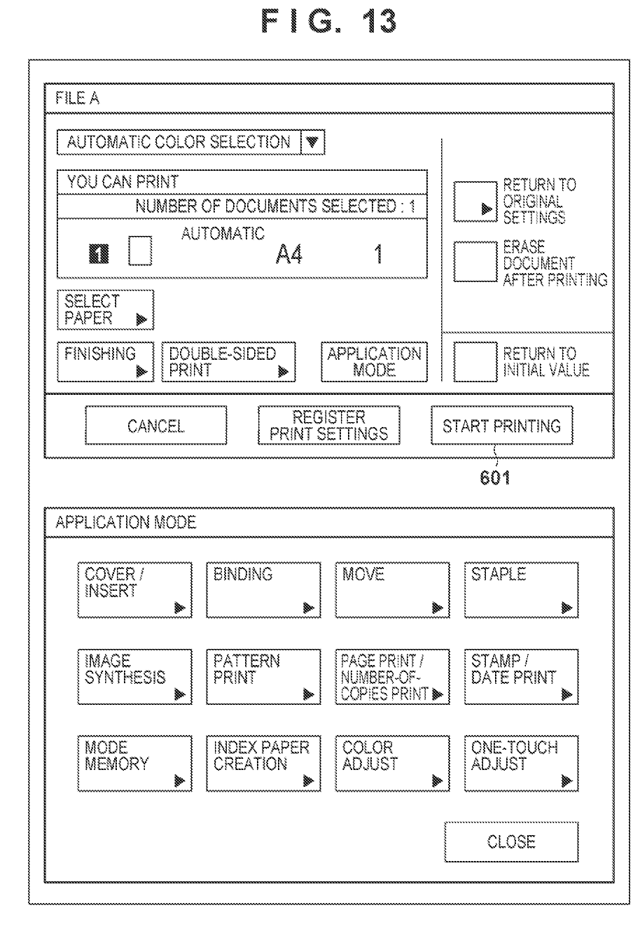

In this display, the panel controller (PANELC) 3106 displays the boxed-document list window, which is shown in FIG. 5B, from starting point P and displays the boxed-document preview window, which is shown in FIG. 12, from starting point Q. FIG. 12 is displaying a preview of a file (here referred to as “File A”) that has been selected by the file name shown in FIG. 11. If a document is selected from the boxed-document list window and a print key 502 is pressed, control proceeds from step S706 to step S707 and the display is changed over to a boxed-document print settings window and an advanced print settings window shown in FIG. 13.

FIG. 13 is a diagram illustrating an example of the boxed-document print settings window and advanced print settings window according to the first embodiment.

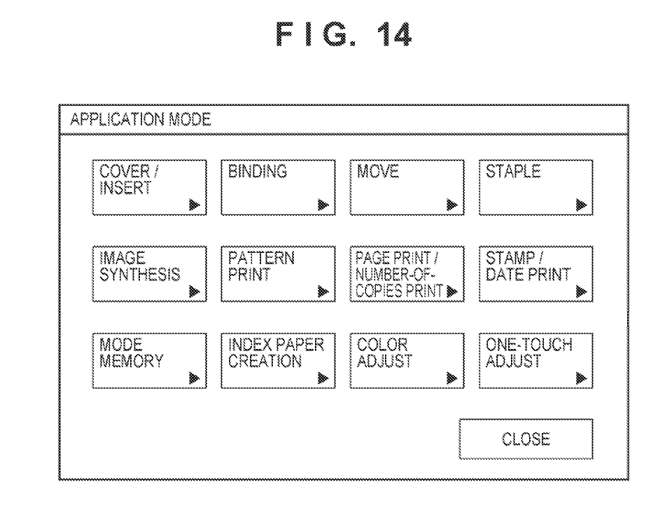

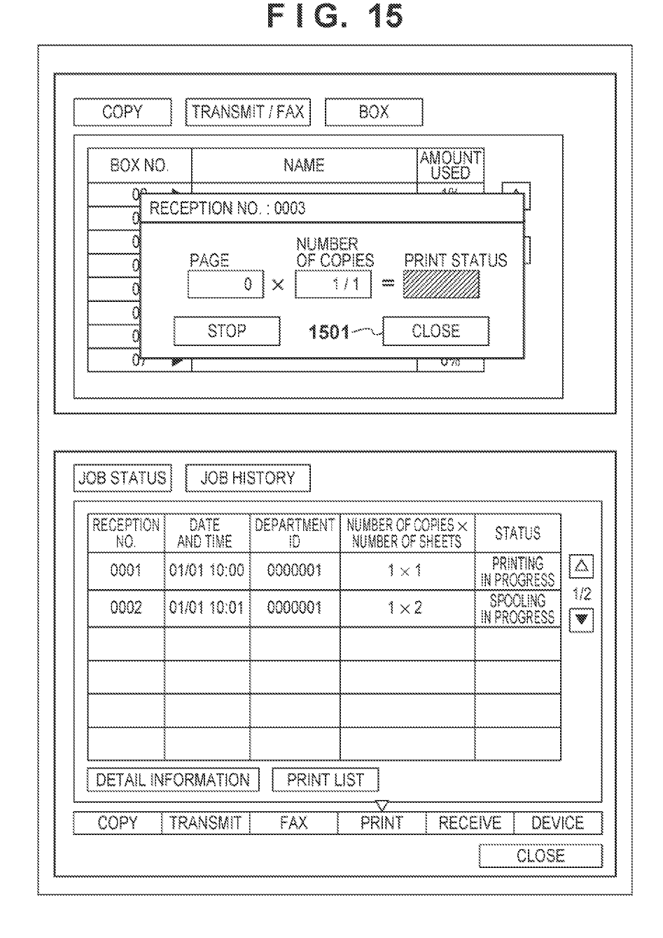

In this display, the panel controller (PANELC) 3106 displays the boxed-document print settings window, which is shown in FIG. 6A, from starting point P, and displays the advanced print settings window, which is shown in FIG. 14, from starting point Q. If a print start key 601 (FIG. 13) in the advanced print settings window is pressed, control proceeds from step S708 to step S709 and the display is changed over to display of a print execution window and job status window shown in FIG. 15.

FIG. 15 is a diagram illustrating an example of a print execution window and job status window according to the first embodiment.

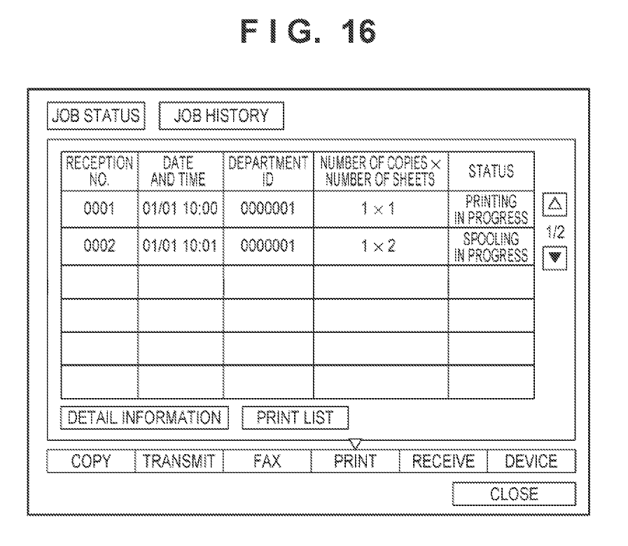

In this display, the panel controller (PANELC) 3106 displays the print execution window, which is shown in FIG. 6B, from starting point P, and displays the job status window, which is shown in FIG. 16, from starting point Q. Control returns to step S702 if, with the print execution window being displayed, a boxed print job is executed or a close key 1501, which is for closing this window, is pressed.

It should be noted that in the case of a setting operation other than that for box processing in step S702, control proceeds to step S710 and other processing is executed. This need not be described here.

In a case where the portrait orientation shown in FIG. 4B is detected by the tilt sensor 3113, the starting points of the units of display data become starting point R(1023,767) and starting point S(511,767) in a manner similar to that described above. It this case also the windows undergo a transition in the manner described above. Although the display presented is the same, the operation display orientation shown in FIG. 4B is a case where the console panel 3000 has been rotation 180° from the operation display orientation shown in FIG. 4A. In this case, if the units of display data being held in flash ROM 3107 are developed in RAM 3108 in accordance with the starting points, then the display presented on the screen will be observed to transition by following up the 180° of rotation of the console panel 3000.

Next, a case where the landscape orientation shown in FIG. 4C has been detected by the tilt sensor 3113 will be described.

In the case of the operation display orientation shown in FIG. 4C, the unit of display data in the box selection window of FIG. 5A described above is developed in RAM 3108 in the direction of a diagonal point (0,767) from starting point T (1023,0). In this case, each window described in relation to FIG. 4A is replaced by a landscape-oriented window, which is a window for the case where the landscape orientation has been detected. In other words, the panel controller (PANELC) 3106 rewrites the box selection window of FIG. 10 and displays it as the box selection window of FIG. 5A and rewrites the boxed-document list window of FIG. 11 and displays it as the boxed-document list window of FIG. 5B. Furthermore, the panel controller (PANELC) 3106 rewrites the print settings window of FIG. 13 and displays it as the print settings window of FIG. 6A and rewrites the print execution window of FIG. 15 and displays it as the print execution window of FIG. 6B. That is, when the console panel 3000 is placed in the landscape orientation, only the main display data unit is displayed.

Next, reference will be had to FIG. 8 to describe data for controlling the display screen when the console panel 3000 is detected to be in the landscape orientation or the portrait orientation.

FIG. 8 depicts an example of a table illustrating combinations of window information (units of display data) displayed from starting points conforming to orientations of the console panel.

A combination ID 801 is an identifier for managing a combination of two windows displayed when the console panel 3000 is in the portrait orientation. A master window ID 802 is an identifier for defining a window, which is displayed when the console panel 3000 is in the landscape orientation, as a master window (main display data unit), and for specifying this master window. A master window name 803 is data indicating the name of the master window ID 802. A slave window ID 804 is an identifier for defining, as a slave window (subordinate display data unit), whichever of the two windows displayed when the console panel 3000 is in the portrait orientation is other than the master window, and for specifying this slave window. A slave window name 805 is data indicating the name of the slave window ID 804. Display type 806 is data for determining in what window arrangement these items of data are used.

Thus, the combination ID 801 corresponds to the operation mode set by the console panel 3000. If the orientation is one (here the portrait orientation) that displays two windows at the time of this operation mode, then the master and slave windows correspond to window information of the respective operation windows that are displayed from first and second starting points. The relationship between master and slave windows shown in FIG. 8 can be changed, added to or deleted by the user at will via the console panel 3000. Alternatively, it may be arranged so that the relationship can be changed, added to or deleted from an external apparatus such as the personal computer 9000 via the LAN 8000.

In a case where the combination ID 801 is “00001”, this corresponds to the window display shown in FIG. 10. That is, the box selection window (FIG. 5A) is displayed as the main display data unit and the main menu screen (FIG. 9) is displayed as the subordinate display data unit. In a case where the combination ID 801 in FIG. 8 is “00002”, this corresponds to the window display shown in FIG. 11. That is, the boxed-document list window (FIG. 5B) is displayed as the main display data unit and the boxed-document preview window (FIG. 12) is displayed as the subordinate display data unit. In a case where the combination ID 801 is “00003” in FIG. 8, this corresponds to the window display shown in FIG. 13. In a case where the combination ID 801 in FIG. 8 is “00004”, this corresponds to the window display shown in FIG. 15.

In accordance with the first embodiment, as described above, units of display data displayed on the screen of the console panel are defined as master and slave windows and the master window is displayed when only one window is displayed in the display area. When two windows are displayed in the display area, the master window and the slave window associated with this master window are displayed simultaneously. As a result, since the optimum screen or screens can be displayed in accordance with the orientation of the console panel 3000, optimum operability conforming to the intentions of the user can be provided.

In the first embodiment, the fact that a master window and a slave window are associated with each other is described citing an example in which two windows are displayed, one above the other, in a case where the orientation of the console panel is the portrait orientation. However, the detection of the orientation of the console panel and the number of windows displayed simultaneously are not limited to this example. For instance, if the orientation is the landscape orientation, two windows may be displayed side by side. Furthermore, the relationship between master and slave windows is not limited to a one-to-one relationship. Further, if data of a combination of a master window and slave window does not exist in case of a setting that displays two units of display data, it is possible to display only the master window instead.

In the first embodiment described above, the orientation of the console panel 3000 is detected using the tilt sensor 3113. In general, the tilt sensor 3113 generally utilizes the force of gravity. If the console panel 3000 has been placed on a horizontal surface, therefore, the tilt sensor 3113 cannot discriminate whether the orientation of the console panel 3000 is portrait or landscape.

### Second Embodiment

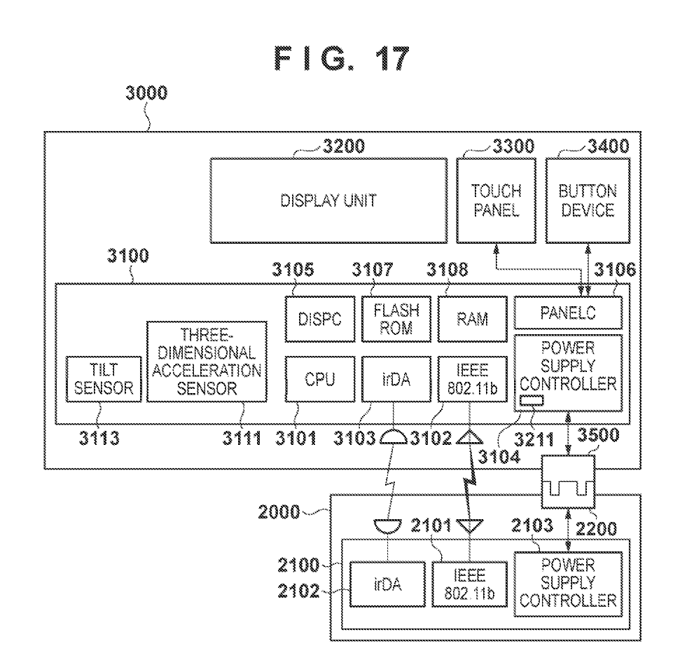

FIG. 17 is a block diagram illustrating the arrangement of the console panel 3000 and home position 2000 in a second embodiment having a three-dimensional accelerations sensor 3111 in addition to the tilt sensor 3113 as means for detecting the orientation of the console panel 3000. The three-dimensional accelerations sensor 3111 has a movable portion inside a semiconductor chip. Fins on the movable portion are moved by externally applied acceleration so that a gap between these fins and fins on a non-movable portion changes, thereby causing a change in electrostatic capacitance. This makes it possible to detect acceleration externally applied to the console panel 3000. By subjecting the signals from these two sensors 3111, 3113 to signal processing, whether the console panel 3000 is in a vertical or horizontal state, whether it has been placed in the portrait or landscape orientation and motion in three dimensions, namely back and forth, left and right and up and down, can be detected accurately. Although piezoelectric-resistance and thermal-detection type sensors, etc., are known as examples of the three-dimensional accelerations sensor 3111, the present invention can be implemented using all of these known types of sensors.

Although not shown in FIG. 17, the configuration of the main unit 1000 is the same as that of the first embodiment and need not be described again. Further, portions in FIG. 17 similar to those shown in FIG. 2 are designated by like reference characters and need not be described again.

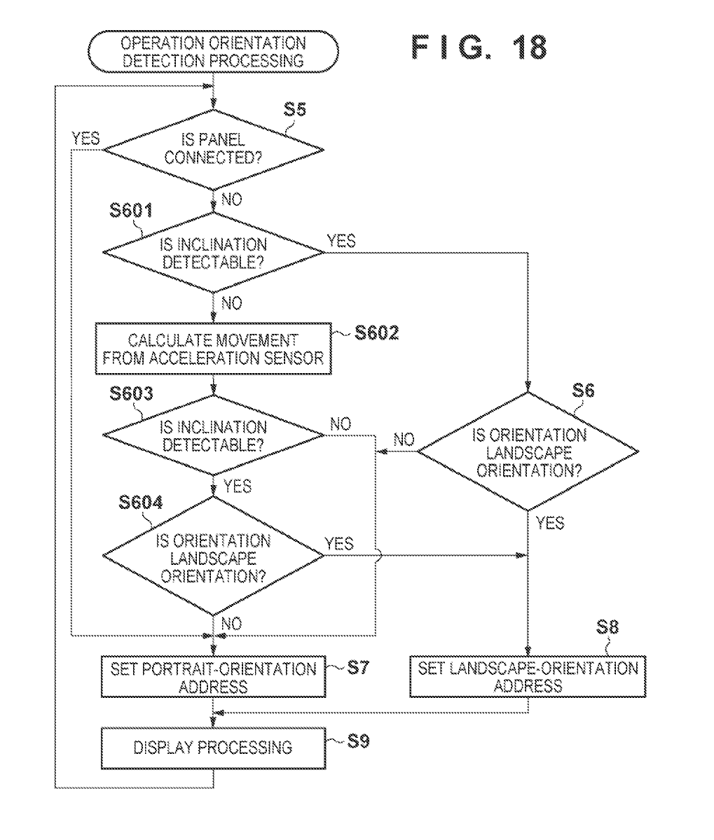

FIG. 18 is a flowchart for describing processing, which is executed by the console panel 3000, for detecting orientation of the console panel 3000 according to the second embodiment. Processing steps identical with those shown in FIG. 3 earlier are designated by like step numbers.

If the console panel 3000 is in the horizontal state and the output of the tilt sensor 3113 is small and cannot be detected stably, control proceeds from step S601 to step S602, where the output of the three-dimensional acceleration sensor 3111 is processed and the orientation of the console panel 3000 detected. In step S602, the output of the tilt sensor 3113 is adopted as an initial value, the output of the acceleration sensor 3111 is integrated twice, the distance moved from the initial value in directions along the three dimensions is calculated and inclination with respect to the horizontal plane is determined. It should be noted that if there is no movement of the console panel 3000 in a case where, with the console panel 3000 in the horizontal state, the power supply of the console panel 3000 is turned on or the tilt sensor 3113 is reset, then the initial position will be indeterminate even though the tilt sensor 3113 is used. In this case, therefore, whether detection of inclination is possible or not is determined in step S603. When it is determined in step S603 that detection is not possible, control proceeds to step S7 and it is decided that the orientation is the portrait orientation. On the other hand, if amount of movement can be calculated from the output of the acceleration sensor 3111, the orientation of the console panel 3000 is determined in step S604 and control branches to step S7 or step S8 depending upon the result of this determination.

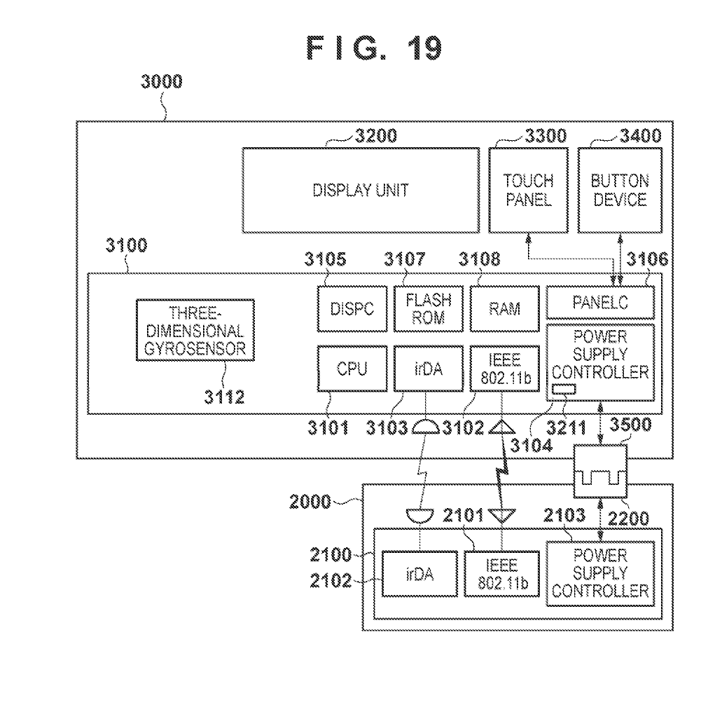

FIG. 19 is a block diagram illustrating the arrangement of the console panel 3000 and home position 2000 according to another embodiment having a three-dimensional gyrosensor 3112 instead of the above-mentioned sensors. Portions in FIG. 19 similar to those shown in FIG. 2 are designated by like reference characters and need not be described again.

The three-dimensional gyrosensor 3112 makes it possible to detect the orientation of the console panel 3000 in accordance with the flowchart of FIG. 3, described above, regardless of the attitude of the console panel 3000. It should be noted that the three-dimensional gyrosensor 3112 is a semiconductor element of the type that utilizes the Coriolis force.

Since the arrangement in which the state of the display presented on the console panel 3000 is changed in conformity with the orientation of the console panel 3000 as detected by the above-mentioned sensors is the same as that of the first embodiment regardless of the sensor used, the arrangement need not be described again.

In accordance with the foregoing embodiments, as described above, at least two units of display data and detection unit(s) for detecting orientation are used in a case where the console panel 3000, which is capable of wireless communication with the main unit 1000, is operated in the portrait or landscape orientation by the operator. The at least two units of display data are laid out and displayed adaptively in conformity with the orientation of the console panel 3000 detected by the detection unit(s). When two units of display data are displayed, two windows associated with the mode of operation at the time are displayed, thereby making it possible to display for the user an operation screen made to conform to the orientation of the console panel 3000. Further, since the user can set combinations of master and slave windows in the table shown in FIG. 8, the desired master and slave windows can be displayed in response to a change in the orientation of the console panel 3000 while a master window is being displayed.

### Other Embodiments

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-017115, filed Jan. 28, 2011, which is hereby incorporated by reference herein in its entirety.

What is claimed is:

1. An image display apparatus comprising:
a detection unit configured to detect orientation of the image display apparatus;
a display unit configured to display an image based upon image data that has been stored in a display memory;
a storage unit configured to manage and store screen information, which is displayed on the display unit in accordance with mode of operation, at least as main and subordinate display data units; and
a display control unit configured to exercise control in such a manner that the display data units that have been stored in the storage unit are developed from prescribed addresses of the display memory and displayed on the display unit in accordance with the mode of operation and the orientation that has been detected by the detection unit;
wherein in the case of a mode of operation that displays at least two operation screens on the display unit, the display control unit lays out and displays each of the main and subordinate display data units on the screen of the display unit.

2. The apparatus according to claim 1, wherein in case of a mode of operation that displays only one operation screen on the display unit, the display control unit displays only the main display data unit on the screen of the display unit.

3. The apparatus according to claim 1, wherein the display control unit displays at least two operation screens in a case where a portrait orientation has been detected as the orientation and displays only one operation screen in a case where a landscape orientation has been detected as the orientation.

4. The apparatus according to claim 1, wherein the detection unit has at least a tilt sensor, a three-dimensional gyrosensor and a three-dimensional acceleration sensor.

5. An image display method for controlling an image display apparatus, the method comprising:
a detection step of detecting orientation of the image display apparatus;
a display step of displaying an image based upon image data that has been stored in a display memory;
a storage step of managing and storing, in a memory, screen information, which is displayed on the display unit in accordance with mode of operation, at least as main and subordinate display data units; and
a display control step of exercising control in such a manner that the display data units that have been stored in the memory are developed from prescribed addresses of the display memory and displayed on the display unit in accordance with the mode of operation and the orientation that has been detected in the detection step;
wherein in the case of a mode of operation that displays at least two operation screens on the display unit, each of the main and subordinate display data units are laid out and displayed on the screen of the display unit in the display control step.

6. A non-transitory computer readable storage medium storing program for causing a computer to function as an image display apparatus having:
a detection unit configured to detect orientation of the image display apparatus;
a display unit configured to display an image based upon image data that has been stored in a display memory;
a storage unit configured to manage and store screen information, which is displayed on the display unit in accordance with mode of operation, at least as main and subordinate display data units; and
a display control unit configured to exercise control in such a manner that the display data units that have been stored in the storage unit are developed from prescribed addresses of the display memory and displayed on the display unit in accordance with the mode of operation and the orientation that has been detected by the detection unit;
wherein in the case of a mode of operation that displays at least two operation screens on the display unit, the display control unit lays out and displays each of the main and subordinate display data units on the screen of the display unit.

7. A display apparatus for displaying a screen, comprising:
a detection unit configured to detect orientation of the image display apparatus;
a registration unit configured to associate and register first and second screens in accordance with an instruction from a user; and
a control unit configured to control in such a manner that in response to detection by the detection unit of a change in the orientation of the display apparatus from a first orientation to a second orientation when the first screen is being displayed on the display apparatus, the first screen and the second screen, which has been registered in association with the first screen by the registration unit, are displayed on the screen of the display apparatus.
